(19) United States
(12) Patent Application Publication
(10) Pub. No.: US 2018/0063310 A1
(43) Pub. Date: Mar. 1, 2018

(54) SYSTEMS AND METHODS FOR IDENTIFYING WIRELESS DEVICES FOR CORRECT PAIRING

(71) Applicant: Vocollect, Inc., Pittsburgh, PA (US)

(72) Inventors: Dale McGary, Pittsburgh, PA (US); Ryan A. Zoschg, Pittsburgh, PA (US)

(21) Appl. No.: 15/244,015

(22) Filed: Aug. 23, 2016

(51) Int. Cl. H04M 1/725

(52) U.S. Cl. CPC H04M 1/7253

(57) ABSTRACT

A wireless headset is provided. The wireless headset comprises a headset memory and a processor communicatively coupled to the headset memory. The headset memory is operable to store a unique identifier to identify the wireless headset. The processor is configured to read the unique identifier from the headset memory and transmit a signal representing the unique identifier of the wireless headset to another wireless device such that a screen on the wireless device identifies the wireless headset with the unique identifier. Systems and methods for identifying wireless devices for correct pairing are also provided, such as in the pairing of a Bluetooth-enabled wireless headset with a Bluetooth-enabled wireless mobile device.

### FIELD OF THE INVENTION

The present invention relates to pairing of wireless devices and more particularly relates to systems and methods for identifying wireless devices for correct pairing, such as in the pairing of a Bluetooth-enabled wireless headset with a Bluetooth-enabled wireless mobile device.

### BACKGROUND

Wireless devices with Bluetooth radios (i.e., “Bluetooth-enabled devices” or simply “Bluetooth devices”) must be correctly “paired” with each other before they can communicate. For example, in a work environment, a Bluetooth-enabled wireless mobile device may be configured to be paired with a single particular Bluetooth-enabled wireless headset for helping a user perform specific tasks.

A pairing screen (or simply “screen”) on the Bluetooth-enabled wireless mobile device displays a list of nearby Bluetooth wireless devices (i.e., other Bluetooth-enabled wireless devices that are in Bluetooth range of the Bluetooth-enabled mobile device) and that have been placed in discovery mode (and are thus available for pairing) as well as already-paired Bluetooth-enabled wireless devices. The nearby wireless devices may also be referred to herein as “wireless accessories”. The list may include one or more wireless headsets conventionally identified on the list with the same fixed name that does not identify any single particular headset. For example, referring briefly to FIG. 4, the Bluetooth-enabled headset listed in the pairing screen of conventional wireless mobile device A is identified with the exemplary fixed generic name “SRX-SL”, the model name for the headset. The user may select an available wireless device, such as the Bluetooth-enabled wireless headset, from the list for pairing with his/her respective wireless mobile device. The wireless mobile device then connects wirelessly to the selected wireless accessory, i.e., the wireless mobile device pairs with the selected wireless accessory (the selected wireless accessory also pairs with the wireless mobile device).

In work environments where multiple users are attempting to pair his/her respective wireless mobile device to a single particular wireless headset, for example, at the start of a work shift, an individual user may see more than one wireless headset listed on the pairing screen. As each of the wireless headsets is identified in the list on the pairing screen with the same fixed generic name, the user may select the incorrect wireless headset to pair with his/her respective wireless mobile device. If the incorrect wireless headset is paired with the wireless mobile device, the user may not be able to communicate with the wireless mobile device, necessitating at least one subsequent unpairing to break the connection between the wireless mobile device and the incorrectly paired wireless headset so that the user can try again to pair the wireless mobile device to the correct wireless headset. Thus, the current pairing process may be frustrating, time-consuming, and inefficient. This is particularly true in environments where specific wireless devices are configured to be paired with each other, but multiple wireless accessories such as a wireless headset and more particularly, Bluetooth-enabled wireless headsets with the same fixed generic name appear on the list of available wireless accessories.

Thus, there is a need for systems and methods for identifying wireless devices for correct pairing. There is a particular need for systems and methods for identifying a wireless headset such as a Bluetooth-enabled wireless headset (an exemplary wireless accessory) for correct pairing with another wireless device. Various embodiments permit a user to easily recognize the correct wireless headset on the list displayed on the pairing screen of the wireless device, enabling selection and pairing with his/her respective mobile device and substantially preventing an incorrect pairing, thereby saving time, easing frustration, and improving workplace efficiency.

### SUMMARY

A wireless headset is provided, according to various embodiments. The wireless headset comprises a headset memory and a processor communicatively coupled to the headset memory. The headset memory is operable to store a unique identifier to identify the wireless headset. The processor is configured to read the known unique identifier from the headset memory and transmit a signal representing the known unique identifier of the wireless headset to another wireless device such that a screen on the wireless device identifies the wireless headset with the known unique identifier.

A system is provided for identifying a wireless headset for pairing with another wireless device, according to various embodiments. The system comprises the wireless headset and the wireless device. The wireless headset comprises a headset memory operable to store a unique identifier of the wireless headset and a processor communicatively coupled to the headset memory. The processor is configured to read the unique identifier from the headset memory and transmit a unique identifier signal. The wireless headset is configured to be paired to the wireless device via a wireless communications protocol. The wireless device comprises a memory and a program code resident in the memory, a display configured for displaying a screen for listing the wireless headset as available for pairing, and at least one processing unit communicatively coupled to the memory and the display. The at least one processing unit is configured by at least a portion of the program code to detect the wireless headset, receive the unique identifier signal from the processor of the wireless headset, display the pairing screen, and identify the wireless headset with the unique identifier on the screen.

A method is provided for identifying a wireless headset for pairing to another wireless device, according to various embodiments. The method for identifying a wireless headset for pairing to another wireless device comprises detecting a wireless headset, receiving a unique identifier signal from the wireless headset, displaying the screen, and identifying the wireless headset on the screen with the unique identifier.

The foregoing illustrative summary, as well as other exemplary objectives and/or advantages of the invention, and the manner in which the same are accomplished, are further explained within the following detailed description and its accompanying drawings.

### BRIEF DESCRIPTION OF THE DRAWINGS

FIG. 1 is a flow diagram of a method for identifying wireless devices for pairing, according to various embodiments;

FIG. 2 is a graphical illustration of a user performing a task such as in a warehouse environment, the user communicating via the exemplary wireless headset to an exemplary wireless mobile device that is paired to the wireless headset;

FIG. 3 is a schematic block diagram of hardware and software components of the exemplary wireless mobile devices of FIGS. 2 and 4 and the exemplary wireless headset of FIG. 2 in a system for identifying wireless devices for correct pairing, according to various embodiments; and

FIG. 4 is a side by side comparison of a display of a conventional exemplary wireless mobile device 70A and an exemplary wireless mobile device 70B according to various embodiments, the display of each of wireless mobile device 70A and wireless mobile device 70B displaying a pairing screen with a list of wireless accessories including a wireless headset available for pairing to the wireless mobile device, the wireless headset identified in the list on the pairing screen of the conventional wireless mobile device 70A with a fixed generic name “SRX-SL” and on the pairing screen of wireless mobile device 70B with the unique identifier “SRX-SL Dale” according to various embodiments.

### DETAILED DESCRIPTION

Various embodiments are directed to systems and methods for identifying wireless devices for correct pairing. Various embodiments enable identification of a single particular wireless headset (an exemplary wireless accessory) for correct pairing with another wireless device, such as a wireless mobile device. Various embodiments permit a user to easily recognize which wireless headset listed on a pairing screen of the wireless device is configured to correctly pair with his/her respective wireless mobile device. Various embodiments improve workplace efficiency, and save time and frustration in having to disconnect incorrect pairings. Various embodiments distinguish between shared wireless accessories. As used herein, the term “wireless accessory” is used to distinguish a wireless device that another wireless device is connected to (e.g., a wireless headset) from a wireless device that connects to the wireless accessory (e.g., a wireless mobile device). In accordance with various embodiments, a Bluetooth-enabled wireless headset is communicatively coupled to a Bluetooth-enabled mobile device via a Bluetooth wireless communications protocol.

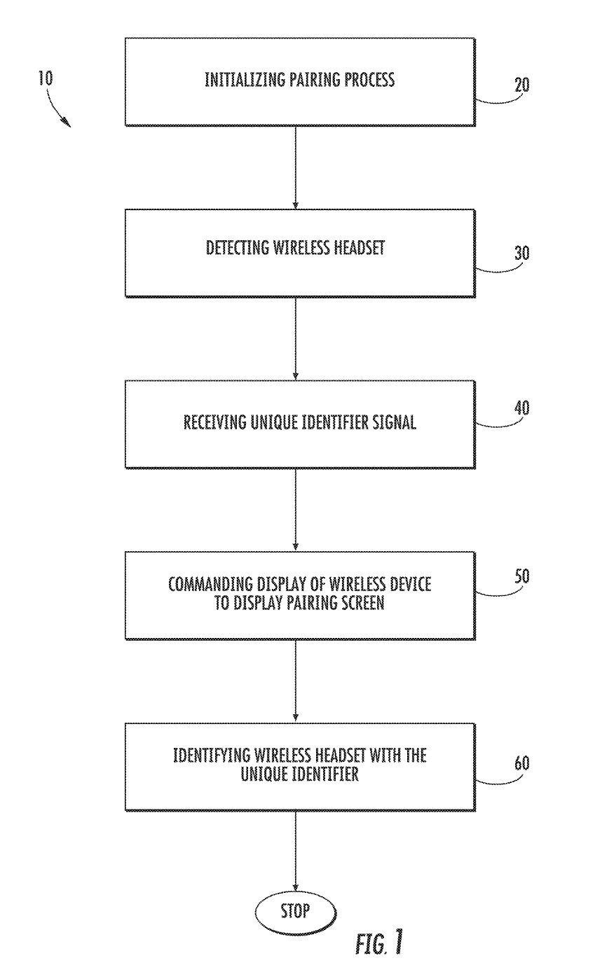

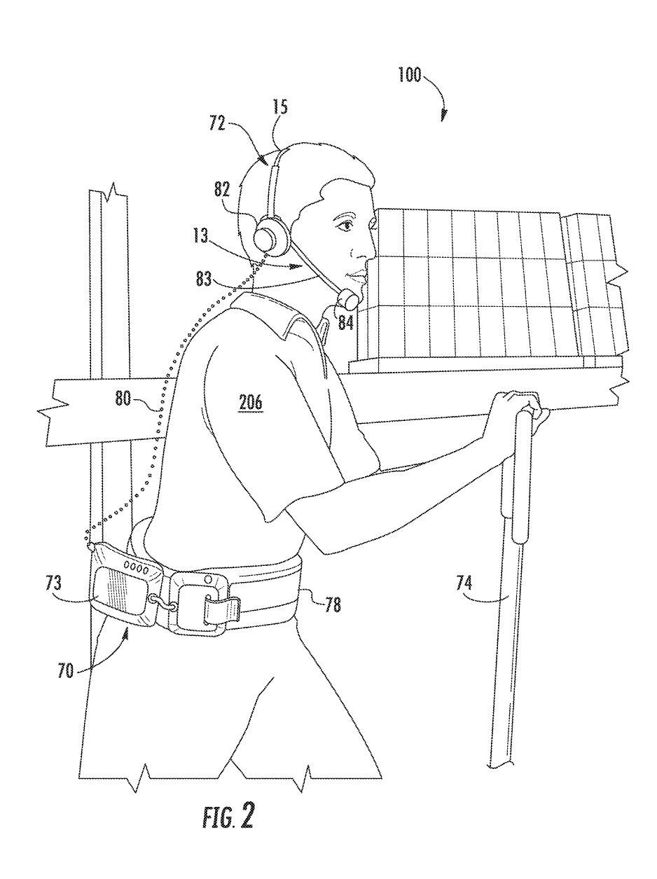

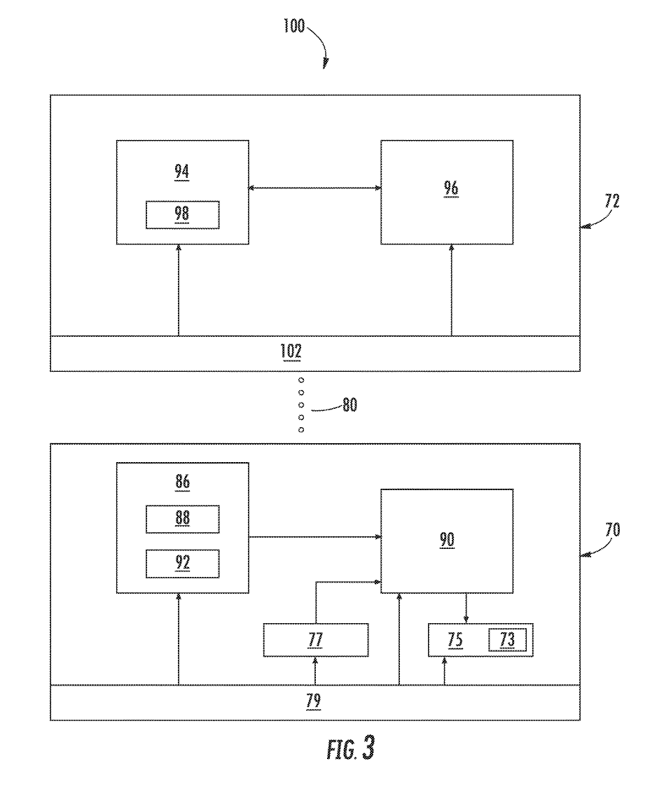

Referring now to FIG. 1, according to various embodiments, a flow diagram of a method 10 for identifying a wireless headset for correct pairing to another wireless device is illustrated. FIG. 2 graphically illustrates an exemplary wireless headset 72 worn by a user 206 and paired to a wireless device comprising a wireless mobile device 70, and used in system 100 (FIG. 3) for identifying the wireless headset 72 for correct pairing to another wireless device, such as the wireless mobile device 70 of FIG. 2, according to various embodiments. The system 100 for identifying the wireless headset for correct pairing to another wireless device comprises the wireless headset 72 and the wireless device (the wireless mobile device 70 in the depicted embodiment) to which the wireless headset 72 is configured to be paired via the Bluetooth wireless communications protocol. For example, in accordance with various embodiments as noted previously, the wireless headset 72 (a wireless accessory) may comprise a Bluetooth-enabled wireless headset and the other wireless device may be a Bluetooth-enabled wireless device such as a Bluetooth mobile device, i.e., the Bluetooth wireless headset may be paired (i.e., communicatively coupled) to the Bluetooth wireless mobile device via the Bluetooth wireless communication protocol as illustrated in FIG. 3.

Still referring to FIG. 2, according to various embodiments, the wireless mobile device 70 comprises a portable and/or wearable mobile computing device worn by the user 206, for example, such as on a belt 78 as illustrated in the depicted embodiment. The wireless mobile device 70 may be carried or otherwise transported, on a vehicle 74 used in the workplace.

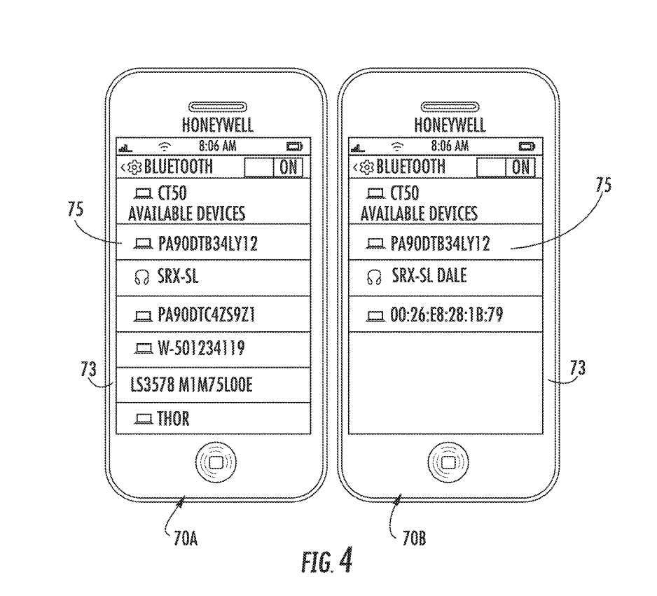

FIG. 3 is a schematic block diagram of at least a portion of the hardware and software components of the wireless mobile device 70 and the wireless headset 72 of FIG. 2, according to various embodiments. The wireless mobile device 70 comprises a memory 86 and a program code 88 resident in the memory 86, a display 73 (FIGS. 2 and 4) configured for displaying a pairing screen 75 as hereinafter described, and at least one processing unit communicatively coupled to the memory 86 and the display 73. The wireless mobile device further comprises a wireless radio 77, such as a Bluetooth radio and a power supply 79, such as a battery, rechargeable battery, rectifier, and/or another power source.

The at least one processing unit 90 of the wireless mobile device 70 is typically implemented in hardware using circuit logic disposed in one or more physical integrated circuit devices, or chips. Each processing unit 90 may be one or more microprocessors, micro-controllers, field programmable gate arrays, or ASICs, while memory 86 may include RAM, DRAM, SRAM, flash memory, and/or another digital storage medium, and that is also typically implemented using circuit logic disposed in one or more physical integrated circuit devices, or chips. As such, memory is considered to include memory storage physically located elsewhere in the wireless mobile device 70, e.g., any cache memory in the at least one processing unit 90, as well as any storage capacity used as a virtual memory, e.g., as stored on a mass storage device, a computer, and/or or another device coupled to the wireless mobile device, including coupled to the wireless mobile device 70 through at least one network I/F by way of a communications network. The wireless mobile device, in turn, may be coupled to the communications network through the network I/F with at least one wired and/or wireless connection.

The wireless mobile device 70 may be under the control and/or otherwise rely upon various software applications, components, programs, files, objects, modules, etc. (herein the “program code” 88 that is resident in memory) according to various embodiments of the present invention. This program code may include an operating system (e.g., such as a Windows Embedded Compact operating system as distributed by Microsoft Corporation of Redmond, Wash., an ANDROID operating system, an IOS operating system, or the like.) as well as one or more software applications (e.g., configured to operate in an operating system or as “stand-alone” applications). As such, the memory may also be configured with one or more task applications 92. The one or more task applications process messages or task instructions for the user (e.g., by displaying and/or converting the task messages or task instructions into speech output). The task application(s) implement a dialog flow, such as for a pick-and-place, voice-assisted, or voice-directed operation. The task application(s) may communicate with a server to receive task messages or task instructions. In various embodiments, suitable exemplary wireless mobile devices for implementing the present invention are a Honeywell CT50 wearable wireless mobile and a Honeywell D75E wireless mobile device available from Honeywell International, Inc.

Still referring to FIGS. 2 and 3, according to various embodiments, the wireless headset 72 is depicted. A “headset” is a device commonly understood to allow two-way communications. The wireless headset 72 comprises a user input/output device. The wireless headset 72 provides hands-free voice communication between the user 206 and the wireless mobile device 70. The wireless headset 72 may be used, for example, in voice-enabled workplace operations (such as a pick to voice picking operation, etc.). In various embodiments, a user 206 may interface with the wireless mobile device 70 (and the wireless mobile device 70 interfaces with the user 206) through the wireless headset 72, which is coupled to the wireless mobile device 70 through a wireless control signal (indicated by dots 80 in FIGS. 2 and 3) as hereinafter described. The wireless mobile device 70 is configured to communicate with the wireless headset 72 through a headset interface, which is in turn configured to couple to the wireless headset wirelessly. In various embodiments, as noted previously, the wireless mobile device 70 may be coupled to the wireless headset 72 through the BlueTooth® wireless communication protocol that is known in the art.

Still referring to FIG. 2, according to various embodiments, the wireless headset 72 comprises a generally U-shaped, resilient headband 15 that can be fitted over the top of the user's head and a receiver assembly 13 rotationally coupled to the headband 15. In various embodiments, the headband 15 may be separable from the receiver assembly. In this regard, each user may have his/her own personal headband.

The receiver assembly 13 comprises an electronics module (FIG. 3) as hereinafter described. The receiver assembly 13 further comprises a microphone boom 83 having a first end and a second end. One or more microphones 84 are located adjacent the first end and can be positioned adjacent the user's mouth as depicted in FIG. 2. One or more speakers 82 are located adjacent the second end of the microphone boom 83 and can be positioned over a user's ear. The one or more speakers are configured to play audio (e.g., such as speech output associated with a voice dialog to instruct the user to perform an action/task), while the one or more microphones are configured to capture speech input from the user (e.g., such as for conversion to machine readable input). As such, the user 206 interfaces with the wireless mobile device 70 hands-free through the wireless headset 72.

Still referring to FIG. 3, according to various embodiments, the receiver assembly 13 (the electronics module) of the wireless headset 72 comprises a headset memory 94 and a processor 96 communicatively coupled to the headset memory 94. In accordance with various embodiments, the headset memory 94 may be additionally or alternatively be in the headband 15 of the wireless headset 72. The headset memory 94 stores the unique identifier (as exemplified by SRX-SL Dale in FIG. 4) that identifies the single particular wireless headset, according to various embodiments. According to various embodiments, the headset memory 94 is configured to store the unique identifier associated with each of the wireless headsets in a unique identifier file 98 within the headset memory. Headset memory 94 may include non-volatile memory. Headset memory 94 may additionally or alternatively comprise an integrated circuit chip that stores a static, unique identifier.

The processor 96 of the wireless headset 72 may be within the receiver assembly and is typically implemented in hardware using circuit logic disposed on one or more physical integrated circuit devices or chips and may be one or more microprocessors, micro-controllers, FPGAs, or ASICs. The wireless headset 72 also comprises a headset power supply. The headset power supply 102 may be a battery, rechargeable battery, rectifier, and/or another power source.

As known in the art, the processor 96 of the wireless headset 72 is configured to transmit and receive the wireless control signal 80 for establishing and at least temporarily maintaining a Bluetooth wireless connection (with the wireless mobile device 70 when the wireless headset 72 is placed in discovery mode. The wireless headset 72 is placed into discovery mode by the user 206 in order to transmit and receive the wireless control signal 80. The exact way to place the wireless headset 72 in discovery mode depends on the wireless headset. For example, the user 206 may need to hold a button down on the headset for several seconds until a light starts flashing. The light may flash to indicate that the wireless headset 72 is in discovery mode. It is to be understood that the wireless headset can be made discoverable in other manners.

Referring again to FIG. 1, according to various embodiments, the method 10 for identifying a wireless headset for correct pairing to another wireless device begins by initializing a pairing process to pair the wireless device to the wireless headset (step 20). The pairing process is initialized by searching for nearby wireless accessories that have been placed in discovery mode. As used herein, the term “nearby” means within Bluetooth wireless range.

While method 10 for identifying a wireless headset for correct pairing to another wireless device is described as performed by the processing unit of the Bluetooth-enabled mobile device, it is to be understood that alternative methods may be performed by the processor of the wireless headset according to various embodiments. For example, such method comprises reading a unique identifier from the headset memory and transmitting a signal representing the unique identifier upon pairing of the wireless headset to another wireless device such that a pairing screen on the wireless device identifies the wireless headset with the unique identifier.

Still referring to FIG. 1, according to various embodiments, the method 10 for identifying a wireless headset for correct pairing to another wireless device continues by detecting the wireless headset (step 30), such as wireless headset 72 depicted in FIG. 3. The processing unit 90 of the wireless mobile device 70 detects the wireless headset 72 by receiving the wireless control signal 80 transmitted from the processor 96 of the wireless headset 72. In accordance with various embodiments, the wireless control signal 80 comprises a Bluetooth inquiry response. In accordance with various embodiments, the Bluetooth friendly name (the unique identifier) is returned as part of the inquiry response during pairing. The processing unit 90 of the wireless mobile device 70 may also detect a wireless control signal comprising the Bluetooth inquiry response from one or more other wireless accessories that are in discovery mode and within wireless range. For example, the processing unit 90 of the wireless mobile device may detect the wireless control signal comprising the Bluetooth inquiry response from each wireless headset that has been placed in discovery mode and is within wireless range. The processing unit 90 of the wireless mobile device 70 may also or alternatively detect the wireless control signal 80 comprising the Bluetooth inquiry response from other wireless accessories available for pairing. For example, referring briefly to FIG. 4, the processing unit 90 of wireless mobile device 70B has detected a wireless control signal comprising the Bluetooth inquiry response from four computers, each identified with a computer icon and a serial number that does not change for the particular computer.

Still referring to FIG. 1, according to various embodiments, the method 10 for identifying a wireless headset for correct pairing to another wireless device continues by receiving the unique identifier signal that identifies the wireless headset (step 40). The processing unit 90 of the wireless mobile device 70 receives the unique identifier signal. The unique identifier signal represents the unique identifier (e.g., SRX-SL Dale on wireless mobile device 70B of FIG. 4). As noted previously, the wireless headset 72 may be one wireless headset of a plurality of wireless headsets in discovery mode and in wireless range of the wireless mobile device 70. The processing unit 90 of the wireless mobile device 70 may receive a unique identifier signal from each wireless headset 72. Each of the wireless headsets 77 is identified on the pairing screen 75 of the wireless mobile device 70 with a different unique identifier, according to various embodiments as hereinafter described.

In accordance with various embodiments, the processor in receiver assembly 13 (the electronics module dynamically changes the inquiry response (the unique identifier) depending on whose headset is communicatively coupled to the wireless mobile device. Therefore, it is possible to customize the headset for the user if the headset memory is in the receiver assembly of the wireless headset. If the headset memory is in the headband and as each user may have his/her own headband, it is possible to customize the headband for the user.

Still referring to FIG. 1, according to various embodiments, the method 10 for identifying a wireless headset for correct pairing to another wireless device continues by commanding the display 73 of the wireless mobile device 70 to display the pairing screen 75 (step 50). The pairing screen 75 displays a list of wireless accessories available for pairing to the wireless mobile device 70, i.e., the pairing screen 75 displays a list of the nearby wireless devices that have been placed in discovery mode as well as any wireless accessories already paired to the wireless device. For example, the pairing screen 75 of mobile device 70B of FIG. 4 lists the wireless accessories placed in discovery mode and within wireless range under the heading “Available Devices” (i.e., available to be paired with a wireless mobile device 70 such as depicted in FIGS. 2 and 4). Still referring to FIGS. 1 and 4, according to various embodiments, the method 10 for identifying a wireless headset for correct pairing to another wireless device continues by identifying the wireless headset with the unique identifier on the pairing screen (step 60). The processing unit 90 is configured to identify the wireless headset 72 with the unique identifier on the pairing screen. For example, the pairing screen 75 of exemplary wireless mobile device 70B in FIG. 4 displays an icon representing the wireless headset with the unique known identifier “SRX-SL-Dale” that is unique to a headset user named “Dale”. While the unique identifier “SRX-SL-Dale” is illustrated, it is to be understood that other unique identifiers may be used. The unique identifier may be unique to the particular user. In addition, while the unique identifier “SRX-SL-Dale” includes the fixed generic name “SRX-SL” and the personal name “Dale”, it is to be understood that the unique identifier may be any characters, letters, numbers, etc. that identify a user of a particular wireless headset. It is not necessary that the fixed generic name be included in the unique identifier. As used herein, the term “device identifier” includes both fixed generic names and unique identifiers and is used herein to refer to wireless devices displaying a generic name and devices displaying a unique identifier, in accordance with various embodiments. Therefore, each wireless headset broadcasts a device identifier, with the device identifier for at least one of the listed wireless headsets is unique to that wireless headset.

While the pairing screen of Bluetooth wireless mobile device 70B in FIG. 4 includes only one listed wireless headset, it is to be understood that the list on the pairing screen of a wireless mobile device may include one or more wireless headsets as well as other wireless accessories if detected in step 30. Each wireless headset of the plural of wireless headsets is identified on the paring screen 75 with a different unique identifier, according to various embodiments. Each wireless headset of the plurality of wireless headsets may be labeled or otherwise with the unique identifier and/or the user can be made aware of the unique identifier for his/her own wireless headset to easily and quickly identify the correct wireless headset from the list on the pairing screen of his/her wireless device, such as on the wireless mobile device 70B of FIG. 4.

Thereafter, as known in the art, to complete the pairing process, the user selects the wireless accessory to be paired with his/her wireless device from the pairing screen on the wireless device. The wireless device then connects wirelessly to the selected wireless accessory. In accordance with various embodiments, as the user knows the unique identifier (the “unique identifier”) for the wireless headset that he/she is wearing or holding (for example, by reference to a label or otherwise on the wireless headset, by memory, etc.), the user may select the wireless headset identified with the unique identifier for pairing with his/her wireless device, such as the wireless mobile device 70B depicted in FIG. 4. The wireless mobile device then connects wirelessly to the selected wireless headset, resulting in a correct pairing. Correct pairing of the particular wireless headset with the user's wireless device enables the user wearing the wireless headset to communicate with the wireless device to which it is paired.

While a wireless headset 72 has been described as configured for pairing to a wireless mobile device 70 (“another wireless device”), it is to be understood that a wireless device other than a wireless headset may be configured for pairing to another wireless device according to various embodiments. While a wireless headset configured for pairing with a wireless mobile device has been described, it is to be understood that the wireless headset and other wireless accessories may be configured to pair with other than a wireless mobile device according to various embodiments. While a Bluetooth-enabled wireless mobile device has been described as configured for pairing to a Bluetooth-enabled wireless headset (and vice versa), it is to be understood that other Bluetooth-enabled wireless devices configured to be paired may benefit from various embodiments as described herein.

Various embodiments enable each wireless headset to transmit a unique identifier signal that is listed on the pairing screen of another wireless device to which the wireless headset is configured to be paired, enabling each user to select the correct headset for correct pairing with his/her respective wireless device. Various embodiments improve workplace efficiency, and save time and frustration in having to disconnect incorrect pairings. Various embodiments distinguish between shared wireless accessories, such as shared wireless headsets.

To supplement the present disclosure, this application incorporates entirely by reference the following commonly assigned patents, patent application publications, and patent applications:
U.S. Pat. No. 6,832,725; U.S. Pat. No. 7,128,266;
U.S. Pat. No. 7,159,783; U.S. Pat. No. 7,413,127;
U.S. Pat. No. 7,726,575; U.S. Pat. No. 8,294,969;
U.S. Pat. No. 8,317,105; U.S. Pat. No. 8,322,622;
U.S. Pat. No. 8,366,005; U.S. Pat. No. 8,371,507;
U.S. Pat. No. 8,376,233; U.S. Pat. No. 8,381,979;
U.S. Pat. No. 8,390,909; U.S. Pat. No. 8,408,464;
U.S. Pat. No. 8,408,468; U.S. Pat. No. 8,408,469;
U.S. Pat. No. 8,424,768; U.S. Pat. No. 8,448,863;
U.S. Pat. No. 8,457,013; U.S. Pat. No. 8,459,557;
U.S. Pat. No. 8,469,272; U.S. Pat. No. 8,474,712;
U.S. Pat. No. 8,479,992; U.S. Pat. No. 8,490,877;
U.S. Pat. No. 8,517,271; U.S. Pat. No. 8,523,076;
U.S. Pat. No. 8,528,818; U.S. Pat. No. 8,544,737;
U.S. Pat. No. 8,548,242; U.S. Pat. No. 8,548,420;
U.S. Pat. No. 8,550,335; U.S. Pat. No. 8,550,354;
U.S. Pat. No. 8,550,357; U.S. Pat. No. 8,556,174;
U.S. Pat. No. 8,556,176; U.S. Pat. No. 8,556,177;
U.S. Pat. No. 8,559,767; U.S. Pat. No. 8,599,957;
U.S. Pat. No. 8,561,895; U.S. Pat. No. 8,561,903;
U.S. Pat. No. 8,561,905; U.S. Pat. No. 8,565,107;
U.S. Pat. No. 8,571,307; U.S. Pat. No. 8,579,200;
U.S. Pat. No. 8,583,924; U.S. Pat. No. 8,584,945;
U.S. Pat. No. 8,587,595; U.S. Pat. No. 8,587,697;
U.S. Pat. No. 8,588,869; U.S. Pat. No. 8,590,789;
U.S. Pat. No. 8,596,539; U.S. Pat. No. 8,596,542;
U.S. Pat. No. 8,596,543; U.S. Pat. No. 8,599,271;
U.S. Pat. No. 8,599,957; U.S. Pat. No. 8,600,158;
U.S. Pat. No. 8,600,167; U.S. Pat. No. 8,602,309;
U.S. Pat. No. 8,608,053; U.S. Pat. No. 8,608,071;
U.S. Pat. No. 8,611,309; U.S. Pat. No. 8,615,487;
U.S. Pat. No. 8,616,454; U.S. Pat. No. 8,621,123;
U.S. Pat. No. 8,622,303; U.S. Pat. No. 8,628,013;
U.S. Pat. No. 8,628,015; U.S. Pat. No. 8,628,016;
U.S. Pat. No. 8,629,926; U.S. Pat. No. 8,630,491;
U.S. Pat. No. 8,635,309; U.S. Pat. No. 8,636,200;
U.S. Pat. No. 8,636,212; U.S. Pat. No. 8,636,215;
U.S. Pat. No. 8,636,224; U.S. Pat. No. 8,638,806;
U.S. Pat. No. 8,640,958; U.S. Pat. No. 8,640,960;
U.S. Pat. No. 8,643,717; U.S. Pat. No. 8,646,692;
U.S. Pat. No. 8,646,694; U.S. Pat. No. 8,657,200;
U.S. Pat. No. 8,659,397; U.S. Pat. No. 8,668,149;
U.S. Pat. No. 8,678,285; U.S. Pat. No. 8,678,286;
U.S. Pat. No. 8,682,077; U.S. Pat. No. 8,687,282;
U.S. Pat. No. 8,692,927; U.S. Pat. No. 8,695,880;
U.S. Pat. No. 8,698,949; U.S. Pat. No. 8,717,494;
U.S. Pat. No. 8,717,494; U.S. Pat. No. 8,720,783;
U.S. Pat. No. 8,723,804; U.S. Pat. No. 8,723,904;
U.S. Pat. No. 8,727,223; U.S. Pat. No. D702,237;
U.S. Pat. No. 8,740,082; U.S. Pat. No. 8,740,085;
U.S. Pat. No. 8,746,563; U.S. Pat. No. 8,750,445;
U.S. Pat. No. 8,752,766; U.S. Pat. No. 8,756,059;
U.S. Pat. No. 8,757,495; U.S. Pat. No. 8,760,563;
U.S. Pat. No. 8,763,909; U.S. Pat. No. 8,777,108;
U.S. Pat. No. 8,777,109; U.S. Pat. No. 8,779,898;
U.S. Pat. No. 8,781,520; U.S. Pat. No. 8,783,573;
U.S. Pat. No. 8,789,757; U.S. Pat. No. 8,789,758;
U.S. Pat. No. 8,789,759; U.S. Pat. No. 8,794,520;
U.S. Pat. No. 8,794,522; U.S. Pat. No. 8,794,525;
U.S. Pat. No. 8,794,526; U.S. Pat. No. 8,798,367;
U.S. Pat. No. 8,807,431; U.S. Pat. No. 8,807,432;
U.S. Pat. No. 8,820,630; U.S. Pat. No. 8,822,848;
U.S. Pat. No. 8,824,692; U.S. Pat. No. 8,824,696;
U.S. Pat. No. 8,842,849; U.S. Pat. No. 8,844,822;
U.S. Pat. No. 8,844,823; U.S. Pat. No. 8,849,019;
U.S. Pat. No. 8,851,383; U.S. Pat. No. 8,854,633;
U.S. Pat. No. 8,866,963; U.S. Pat. No. 8,868,421;
U.S. Pat. No. 8,868,519; U.S. Pat. No. 8,868,802;
U.S. Pat. No. 8,868,803; U.S. Pat. No. 8,870,074;
U.S. Pat. No. 8,879,639; U.S. Pat. No. 8,880,426;
U.S. Pat. No. 8,881,983; U.S. Pat. No. 8,881,987;
U.S. Pat. No. 8,903,172; U.S. Pat. No. 8,908,995;
U.S. Pat. No. 8,910,870; U.S. Pat. No. 8,910,875;
U.S. Pat. No. 8,914,290; U.S. Pat. No. 8,914,788;
U.S. Pat. No. 8,915,439; U.S. Pat. No. 8,915,444;
U.S. Pat. No. 8,916,789; U.S. Pat. No. 8,918,250;
U.S. Pat. No. 8,918,564; U.S. Pat. No. 8,925,818;
U.S. Pat. No. 8,939,374; U.S. Pat. No. 8,942,480;
U.S. Pat. No. 8,944,313; U.S. Pat. No. 8,944,327;
U.S. Pat. No. 8,944,332; U.S. Pat. No. 8,950,678;
U.S. Pat. No. 8,967,468; U.S. Pat. No. 8,971,346;
U.S. Pat. No. 8,976,030; U.S. Pat. No. 8,976,368;
U.S. Pat. No. 8,978,981; U.S. Pat. No. 8,978,983;
U.S. Pat. No. 8,978,984; U.S. Pat. No. 8,985,456;
U.S. Pat. No. 8,985,457; U.S. Pat. No. 8,985,459;
U.S. Pat. No. 8,985,461; U.S. Pat. No. 8,988,578;
U.S. Pat. No. 8,988,590; U.S. Pat. No. 8,991,704;
U.S. Pat. No. 8,996,194; U.S. Pat. No. 8,996,384;
U.S. Pat. No. 9,002,641; U.S. Pat. No. 9,007,368;
U.S. Pat. No. 9,010,641; U.S. Pat. No. 9,015,513;
U.S. Pat. No. 9,016,576; U.S. Pat. No. 9,022,288;
U.S. Pat. No. 9,030,964; U.S. Pat. No. 9,033,240;
U.S. Pat. No. 9,033,242; U.S. Pat. No. 9,036,054;
U.S. Pat. No. 9,037,344; U.S. Pat. No. 9,038,911;
U.S. Pat. No. 9,038,915; U.S. Pat. No. 9,047,098;
U.S. Pat. No. 9,047,359; U.S. Pat. No. 9,047,420;
U.S. Pat. No. 9,047,525; U.S. Pat. No. 9,047,531;
U.S. Pat. No. 9,053,055; U.S. Pat. No. 9,053,378;
U.S. Pat. No. 9,053,380; U.S. Pat. No. 9,058,526;
U.S. Pat. No. 9,064,165; U.S. Pat. No. 9,064,167;
U.S. Pat. No. 9,064,168; U.S. Pat. No. 9,064,254;
U.S. Pat. No. 9,066,032; U.S. Pat. No. 9,070,032;
U.S. Design Pat. No. D716,285;
U.S. Design Pat. No. D723,560;
U.S. Design Pat. No. D730,357;
U.S. Design Pat. No. D730,901;
U.S. Design Pat. No. D730,902;
U.S. Design Pat. No. D733,112;
U.S. Design Pat. No. D734,339;
International Publication No. 2013/163789;
International Publication No. 2013/173985;
International Publication No. 2014/019130;
International Publication No. 2014/110495;
U.S. Patent Application Publication No. 2008/0185432;
U.S. Patent Application Publication No. 2009/0134221;
U.S. Patent Application Publication No. 2010/0177080;
U.S. Patent Application Publication No. 2010/0177076;
U.S. Patent Application Publication No. 2010/0177707;
U.S. Patent Application Publication No. 2010/0177749;
U.S. Patent Application Publication No. 2010/0265880;
U.S. Patent Application Publication No. 2011/0202554;
U.S. Patent Application Publication No. 2012/0111946;
U.S. Patent Application Publication No. 2012/0168511;
U.S. Patent Application Publication No. 2012/0168512;
U.S. Patent Application Publication No. 2012/0193423;
U.S. Patent Application Publication No. 2012/0203647;
U.S. Patent Application Publication No. 2012/0223141;
U.S. Patent Application Publication No. 2012/0228382;
U.S. Patent Application Publication No. 2012/0248188;
U.S. Patent Application Publication No. 2013/0043312;
U.S. Patent Application Publication No. 2013/0082104;
U.S. Patent Application Publication No. 2013/0175341;
U.S. Patent Application Publication No. 2013/0175343;
U.S. Patent Application Publication No. 2013/0257744;
U.S. Patent Application Publication No. 2013/0257759;
U.S. Patent Application Publication No. 2013/0270346;
U.S. Patent Application Publication No. 2013/0287258;
U.S. Patent Application Publication No. 2013/0292475;
U.S. Patent Application Publication No. 2013/0292477;
U.S. Patent Application Publication No. 2013/0293539;
U.S. Patent Application Publication No. 2013/0293540;
U.S. Patent Application Publication No. 2013/0306728;
U.S. Patent Application Publication No. 2013/0306731;
U.S. Patent Application Publication No. 2013/0307964;
U.S. Patent Application Publication No. 2013/0308625;
U.S. Patent Application Publication No. 2013/0313324;
U.S. Patent Application Publication No. 2013/0313325;
U.S. Patent Application Publication No. 2013/0342717;
U.S. Patent Application Publication No. 2014/0001267;
U.S. Patent Application Publication No. 2014/0008439;
U.S. Patent Application Publication No. 2014/0025584;
U.S. Patent Application Publication No. 2014/0034734;
U.S. Patent Application Publication No. 2014/0036848;
U.S. Patent Application Publication No. 2014/0039693;
U.S. Patent Application Publication No. 2014/0042814;
U.S. Patent Application Publication No. 2014/0049120;
U.S. Patent Application Publication No. 2014/0049635;
U.S. Patent Application Publication No. 2014/0061306;
U.S. Patent Application Publication No. 2014/0063289;
U.S. Patent Application Publication No. 2014/0066136;
U.S. Patent Application Publication No. 2014/0067692;
U.S. Patent Application Publication No. 2014/0070005;
U.S. Patent Application Publication No. 2014/0071840;
U.S. Patent Application Publication No. 2014/0074746;
U.S. Patent Application Publication No. 2014/0076974;
U.S. Patent Application Publication No. 2014/0078341;
U.S. Patent Application Publication No. 2014/0078345;
U.S. Patent Application Publication No. 2014/0097249;
U.S. Patent Application Publication No. 2014/0098792;
U.S. Patent Application Publication No. 2014/0100813;
U.S. Patent Application Publication No. 2014/0103115;
U.S. Patent Application Publication No. 2014/0104413;
U.S. Patent Application Publication No. 2014/0104414;
U.S. Patent Application Publication No. 2014/0104416;
U.S. Patent Application Publication No. 2014/0104451;
U.S. Patent Application Publication No. 2014/0106594;
U.S. Patent Application Publication No. 2014/0106725;
U.S. Patent Application Publication No. 2014/0108010;
U.S. Patent Application Publication No. 2014/0108402;
U.S. Patent Application Publication No. 2014/0110485;
U.S. Patent Application Publication No. 2014/0114530;
U.S. Patent Application Publication No. 2014/0124577;
U.S. Patent Application Publication No. 2014/0124579;
U.S. Patent Application Publication No. 2014/0125842;
U.S. Patent Application Publication No. 2014/0125853;
U.S. Patent Application Publication No. 2014/0125999;
U.S. Patent Application Publication No. 2014/0129378;
U.S. Patent Application Publication No. 2014/0131438;
U.S. Patent Application Publication No. 2014/0131441;
U.S. Patent Application Publication No. 2014/0131443;
U.S. Patent Application Publication No. 2014/0131444;
U.S. Patent Application Publication No. 2014/0131445;
U.S. Patent Application Publication No. 2014/0131448;
U.S. Patent Application Publication No. 2014/0133379;
U.S. Patent Application Publication No. 2014/0136208;
U.S. Patent Application Publication No. 2014/0140585;
U.S. Patent Application Publication No. 2014/0151453;
U.S. Patent Application Publication No. 2014/0152882;
U.S. Patent Application Publication No. 2014/0158770;
U.S. Patent Application Publication No. 2014/0159869;
U.S. Patent Application Publication No. 2014/0166755;
U.S. Patent Application Publication No. 2014/0166759;
U.S. Patent Application Publication No. 2014/0168787;
U.S. Patent Application Publication No. 2014/0175165;
U.S. Patent Application Publication No. 2014/0175172;
U.S. Patent Application Publication No. 2014/0191644;
U.S. Patent Application Publication No. 2014/0191913;
U.S. Patent Application Publication No. 2014/0197238;
U.S. Patent Application Publication No. 2014/0197239;
U.S. Patent Application Publication No. 2014/0197304;
U.S. Patent Application Publication No. 2014/0214631;
U.S. Patent Application Publication No. 2014/0217166;
U.S. Patent Application Publication No. 2014/0217180;
U.S. Patent Application Publication No. 2014/0231500;
U.S. Patent Application Publication No. 2014/0232930;
U.S. Patent Application Publication No. 2014/0247315;
U.S. Patent Application Publication No. 2014/0263493;
U.S. Patent Application Publication No. 2014/0263645;
U.S. Patent Application Publication No. 2014/0267609;
U.S. Patent Application Publication No. 2014/0270196;
U.S. Patent Application Publication No. 2014/0270229;
U.S. Patent Application Publication No. 2014/0278387;
U.S. Patent Application Publication No. 2014/0278391;
U.S. Patent Application Publication No. 2014/0282210;
U.S. Patent Application Publication No. 2014/0284384;
U.S. Patent Application Publication No. 2014/0288933;
U.S. Patent Application Publication No. 2014/0297058;
U.S. Patent Application Publication No. 2014/0299665;
U.S. Patent Application Publication No. 2014/0312121;
U.S. Patent Application Publication No. 2014/0319220;
U.S. Patent Application Publication No. 2014/0319221;
U.S. Patent Application Publication No. 2014/0326787;
U.S. Patent Application Publication No. 2014/0332590;
U.S. Patent Application Publication No. 2014/0344943;
U.S. Patent Application Publication No. 2014/0346233;
U.S. Patent Application Publication No. 2014/0351317;
U.S. Patent Application Publication No. 2014/0353373;
U.S. Patent Application Publication No. 2014/0361073;
U.S. Patent Application Publication No. 2014/0361082;
U.S. Patent Application Publication No. 2014/0362184;
U.S. Patent Application Publication No. 2014/0363015;
U.S. Patent Application Publication No. 2014/0369511;
U.S. Patent Application Publication No. 2014/0374483;
U.S. Patent Application Publication No. 2014/0374485;
U.S. Patent Application Publication No. 2015/0001301;
U.S. Patent Application Publication No. 2015/0001304;
U.S. Patent Application Publication No. 2015/0003673;
U.S. Patent Application Publication No. 2015/0009338;
U.S. Patent Application Publication No. 2015/0009610;
U.S. Patent Application Publication No. 2015/0014416;
U.S. Patent Application Publication No. 2015/0021397;
U.S. Patent Application Publication No. 2015/0028102;
U.S. Patent Application Publication No. 2015/0028103;
U.S. Patent Application Publication No. 2015/0028104;
U.S. Patent Application Publication No. 2015/0029002;
U.S. Patent Application Publication No. 2015/0032709;
U.S. Patent Application Publication No. 2015/0039309;
U.S. Patent Application Publication No. 2015/0039878;
U.S. Patent Application Publication No. 2015/0040378;
U.S. Patent Application Publication No. 2015/0048168;
U.S. Patent Application Publication No. 2015/0049347;
U.S. Patent Application Publication No. 2015/0051992;
U.S. Patent Application Publication No. 2015/0053766;
U.S. Patent Application Publication No. 2015/0053768;
U.S. Patent Application Publication No. 2015/0053769;
U.S. Patent Application Publication No. 2015/0060544;
U.S. Patent Application Publication No. 2015/0062366;
U.S. Patent Application Publication No. 2015/0063215;
U.S. Patent Application Publication No. 2015/0063676;
U.S. Patent Application Publication No. 2015/0069130;
U.S. Patent Application Publication No. 2015/0071819;
U.S. Patent Application Publication No. 2015/0083800;
U.S. Patent Application Publication No. 2015/0086114;
U.S. Patent Application Publication No. 2015/0088522;
U.S. Patent Application Publication No. 2015/0096872;
U.S. Patent Application Publication No. 2015/0099557;
U.S. Patent Application Publication No. 2015/0100196;
U.S. Patent Application Publication No. 2015/0102109;
U.S. Patent Application Publication No. 2015/0115035;
U.S. Patent Application Publication No. 2015/0127791;
U.S. Patent Application Publication No. 2015/0128116;
U.S. Patent Application Publication No. 2015/0129659;
U.S. Patent Application Publication No. 2015/0133047;
U.S. Patent Application Publication No. 2015/0134470;
U.S. Patent Application Publication No. 2015/0136851;
U.S. Patent Application Publication No. 2015/0136854;
U.S. Patent Application Publication No. 2015/0142492;
U.S. Patent Application Publication No. 2015/0144692;
U.S. Patent Application Publication No. 2015/0144698;
U.S. Patent Application Publication No. 2015/0144701;
U.S. Patent Application Publication No. 2015/0149946;
U.S. Patent Application Publication No. 2015/0161429;
U.S. Patent Application Publication No. 2015/0169925;
U.S. Patent Application Publication No. 2015/0169929;
U.S. Patent Application Publication No. 2015/0178523;
U.S. Patent Application Publication No. 2015/0178534;
U.S. Patent Application Publication No. 2015/0178535;
U.S. Patent Application Publication No. 2015/0178536;
U.S. Patent Application Publication No. 2015/0178537;
U.S. Patent Application Publication No. 2015/0181093;
U.S. Patent Application Publication No. 2015/0181109;
U.S. patent application Ser. No. 13/367,978 for a Laser Scanning Module Employing an Elastomeric U-Hinge Based Laser Scanning Assembly, filed Feb. 7, 2012 (Feng et al.);
U.S. patent application Ser. No. 29/458,405 for an Electronic Device, filed Jun. 19, 2013 (Fitch et al.);
U.S. patent application Ser. No. 29/459,620 for an Electronic Device Enclosure, filed Jul. 2, 2013 (London et al.);
U.S. patent application Ser. No. 29/468,118 for an Electronic Device Case, filed Sep. 26, 2013 (Oberpriller et al.);
U.S. patent application Ser. No. 14/150,393 for Indicia-reader Having Unitary Construction Scanner, filed Jan. 8, 2014 (Colavito et al.);
U.S. patent application Ser. No. 14/200,405 for Indicia Reader for Size-Limited Applications filed Mar. 7, 2014 (Feng et al.);
U.S. patent application Ser. No. 14/231,898 for Hand-Mounted Indicia-Reading Device with Finger Motion Triggering filed Apr. 1, 2014 (Van Horn et al.);
U.S. patent application Ser. No. 29/486,759 for an Imaging Terminal, filed Apr. 2, 2014 (Oberpriller et al.);
U.S. patent application Ser. No. 14/257,364 for Docking System and Method Using Near Field Communication filed Apr. 21, 2014 (Showering);
U.S. patent application Ser. No. 14/264,173 for Autofocus Lens System for Indicia Readers filed Apr. 29, 2014 (Ackley et al.);
U.S. patent application Ser. No. 14/277,337 for MULTIPURPOSE OPTICAL READER, filed May 14, 2014 (Jovanovski et al.);
U.S. patent application Ser. No. 14/283,282 for TERMINAL HAVING ILLUMINATION AND FOCUS CONTROL filed May 21, 2014 (Liu et al.);
U.S. patent application Ser. No. 14/327,827 for a MOBILE-PHONE ADAPTER FOR ELECTRONIC TRANSACTIONS, filed Jul. 10, 2014 (Hejl);
U.S. patent application Ser. No. 14/334,934 for a SYSTEM AND METHOD FOR INDICIA VERIFICATION, filed Jul. 18, 2014 (Hejl);
U.S. patent application Ser. No. 14/339,708 for LASER SCANNING CODE SYMBOL READING SYSTEM, filed Jul. 24, 2014 (Xian et al.);
U.S. patent application Ser. No. 14/340,627 for an AXIALLY REINFORCED FLEXIBLE SCAN ELEMENT, filed Jul. 25, 2014 (Rueblinger et al.);
U.S. patent application Ser. No. 14/446,391 for MULTIFUNCTION POINT OF SALE APPARATUS WITH OPTICAL SIGNATURE CAPTURE filed Jul. 30, 2014 (Good et al.);
U.S. patent application Ser. No. 14/452,697 for INTERACTIVE INDICIA READER, filed Aug. 6, 2014 (Todeschini);
U.S. patent application Ser. No. 14/453,019 for DIMENSIONING SYSTEM WITH GUIDED ALIGNMENT, filed Aug. 6, 2014 (Li et al.);
U.S. patent application Ser. No. 14/462,801 for MOBILE COMPUTING DEVICE WITH DATA COGNITION SOFTWARE, filed on Aug. 19, 2014 (Todeschini et al.);
U.S. patent application Ser. No. 14/483,056 for VARIABLE DEPTH OF FIELD BARCODE SCANNER filed Sep. 10, 2014 (McCloskey et al.);
U.S. patent application Ser. No. 14/513,808 for IDENTIFYING INVENTORY ITEMS IN A STORAGE FACILITY filed Oct. 14, 2014 (Singel et al.);
U.S. patent application Ser. No. 14/519,195 for HANDHELD DIMENSIONING SYSTEM WITH FEEDBACK filed Oct. 21, 2014 (Laffargue et al.);
U.S. patent application Ser. No. 14/519,179 for DIMENSIONING SYSTEM WITH MULTIPATH INTERFERENCE MITIGATION filed Oct. 21, 2014 (Thuries et al.);
U.S. patent application Ser. No. 14/519,211 for SYSTEM AND METHOD FOR DIMENSIONING filed Oct. 21, 2014 (Ackley et al.);
U.S. patent application Ser. No. 14/519,233 for HANDHELD DIMENSIONER WITH DATA-QUALITY INDICATION filed Oct. 21, 2014 (Laffargue et al.);
U.S. patent application Ser. No. 14/519,249 for HANDHELD DIMENSIONING SYSTEM WITH MEASUREMENT-CONFORMANCE FEEDBACK filed Oct. 21, 2014 (Ackley et al.);
U.S. patent application Ser. No. 14/527,191 for METHOD AND SYSTEM FOR RECOGNIZING SPEECH USING WILDCARDS IN AN EXPECTED RESPONSE filed Oct. 29, 2014 (Braho et al.);
U.S. patent application Ser. No. 14/529,563 for ADAPTABLE INTERFACE FOR A MOBILE COMPUTING DEVICE filed Oct. 31, 2014 (Schoon et al.);
U.S. patent application Ser. No. 14/529,857 for BARCODE READER WITH SECURITY FEATURES filed Oct. 31, 2014 (Todeschini et al.);
U.S. patent application Ser. No. 14/398,542 for PORTABLE ELECTRONIC DEVICES HAVING A SEPARATE LOCATION TRIGGER UNIT FOR USE IN CONTROLLING AN APPLICATION UNIT filed Nov. 3, 2014 (Bian et al.);
U.S. patent application Ser. No. 14/531,154 for DIRECTING AN INSPECTOR THROUGH AN INSPECTION filed Nov. 3, 2014 (Miller et al.);
U.S. patent application Ser. No. 14/533,319 for BARCODE SCANNING SYSTEM USING WEARABLE DEVICE WITH EMBEDDED CAMERA filed Nov. 5, 2014 (Todeschini);
U.S. patent application Ser. No. 14/535,764 for CONCATENATED EXPECTED RESPONSES FOR SPEECH RECOGNITION filed Nov. 7, 2014 (Braho et al.);
U.S. patent application Ser. No. 14/568,305 for AUTO-CONTRAST VIEWFINDER FOR AN INDICIA READER filed Dec. 12, 2014 (Todeschini);
U.S. patent application Ser. No. 14/573,022 for DYNAMIC DIAGNOSTIC INDICATOR GENERATION filed Dec. 17, 2014 (Goldsmith);
U.S. patent application Ser. No. 14/578,627 for SAFETY SYSTEM AND METHOD filed Dec. 22, 2014 (Ackley et al.);
U.S. patent application Ser. No. 14/580,262 for MEDIA GATE FOR THERMAL TRANSFER PRINTERS filed Dec. 23, 2014 (Bowles);
U.S. patent application Ser. No. 14/590,024 for SHELVING AND PACKAGE LOCATING SYSTEMS FOR DELIVERY VEHICLES filed Jan. 6, 2015 (Payne);
U.S. patent application Ser. No. 14/596,757 for SYSTEM AND METHOD FOR DETECTING BARCODE PRINTING ERRORS filed Jan. 14, 2015 (Ackley);
U.S. patent application Ser. No. 14/416,147 for OPTICAL READING APPARATUS HAVING VARIABLE SETTINGS filed Jan. 21, 2015 (Chen et al.);
U.S. patent application Ser. No. 14/614,706 for DEVICE FOR SUPPORTING AN ELECTRONIC TOOL ON A USER'S HAND filed Feb. 5, 2015 (Oberpriller et al.);
U.S. patent application Ser. No. 14/614,796 for CARGO APPORTIONMENT TECHNIQUES filed Feb. 5, 2015 (Morton et al.);
U.S. patent application Ser. No. 29/516,892 for TABLE COMPUTER filed Feb. 6, 2015 (Bidwell et al.);
U.S. patent application Ser. No. 14/619,093 for METHODS FOR TRAINING A SPEECH RECOGNITION SYSTEM filed Feb. 11, 2015 (Pecorari);
U.S. patent application Ser. No. 14/628,708 for DEVICE, SYSTEM, AND METHOD FOR DETERMINING THE STATUS OF CHECKOUT LANES filed Feb. 23, 2015 (Todeschini);
U.S. patent application Ser. No. 14/630,841 for TERMINAL INCLUDING IMAGING ASSEMBLY filed Feb. 25, 2015 (Gomez et al.);
U.S. patent application Ser. No. 14/635,346 for SYSTEM AND METHOD FOR RELIABLE STORE-AND-FORWARD DATA HANDLING BY ENCODED INFORMATION READING TERMINALS filed Mar. 2, 2015 (Sevier);
U.S. patent application Ser. No. 29/519,017 for SCANNER filed Mar. 2, 2015 (Zhou et al.);
U.S. patent application Ser. No. 14/405,278 for DESIGN PATTERN FOR SECURE STORE filed Mar. 9, 2015 (Zhu et al.);
U.S. patent application Ser. No. 14/660,970 for DECODABLE INDICIA READING TERMINAL WITH COMBINED ILLUMINATION filed Mar. 18, 2015 (Kearney et al.);
U.S. patent application Ser. No. 14/661,013 for REPROGRAMMING SYSTEM AND METHOD FOR DEVICES INCLUDING PROGRAMMING SYMBOL filed Mar. 18, 2015 (Soule et al.);
U.S. patent application Ser. No. 14/662,922 for MULTIFUNCTION POINT OF SALE SYSTEM filed Mar. 19, 2015 (Van Horn et al.);
U.S. patent application Ser. No. 14/663,638 for VEHICLE MOUNT COMPUTER WITH CONFIGURABLE IGNITION SWITCH BEHAVIOR filed Mar. 20, 2015 (Davis et al.);
U.S. patent application Ser. No. 14/664,063 for METHOD AND APPLICATION FOR SCANNING A BARCODE WITH A SMART DEVICE WHILE CONTINUOUSLY RUNNING AND DISPLAYING AN APPLICATION ON THE SMART DEVICE DISPLAY filed Mar. 20, 2015 (Todeschini);
U.S. patent application Ser. No. 14/669,280 for TRANSFORMING COMPONENTS OF A WEB PAGE TO VOICE PROMPTS filed Mar. 26, 2015 (Funyak et al.);
U.S. patent application Ser. No. 14/674,329 for AIMER FOR BARCODE SCANNING filed Mar. 31, 2015 (Bidwell);
U.S. patent application Ser. No. 14/676,109 for INDICIA READER filed Apr. 1, 2015 (Huck);
U.S. patent application Ser. No. 14/676,327 for DEVICE MANAGEMENT PROXY FOR SECURE DEVICES filed Apr. 1, 2015 (Yeakley et al.);
U.S. patent application Ser. No. 14/676,898 for NAVIGATION SYSTEM CONFIGURED TO INTEGRATE MOTION SENSING DEVICE INPUTS filed Apr. 2, 2015 (Showering);
U.S. patent application Ser. No. 14/679,275 for DIMENSIONING SYSTEM CALIBRATION SYSTEMS AND METHODS filed Apr. 6, 2015 (Laffargue et al.);
U.S. patent application Ser. No. 29/523,098 for HANDLE FOR A TABLET COMPUTER filed Apr. 7, 2015 (Bidwell et al.);
U.S. patent application Ser. No. 14/682,615 for SYSTEM AND METHOD FOR POWER MANAGEMENT OF MOBILE DEVICES filed Apr. 9, 2015 (Murawski et al.);
U.S. patent application Ser. No. 14/686,822 for MULTIPLE PLATFORM SUPPORT SYSTEM AND METHOD filed Apr. 15, 2015 (Qu et al.);
U.S. patent application Ser. No. 14/687,289 for SYSTEM FOR COMMUNICATION VIA A PERIPHERAL HUB filed Apr. 15, 2015 (Kohtz et al.);
U.S. patent application Ser. No. 29/524,186 for SCANNER filed Apr. 17, 2015 (Zhou et al.);
U.S. patent application Ser. No. 14/695,364 for MEDICATION MANAGEMENT SYSTEM filed Apr. 24, 2015 (Sewell et al.);
U.S. patent application Ser. No. 14/695,923 for SECURE UNATTENDED NETWORK AUTHENTICATION filed Apr. 24, 2015 (Kubler et al.);
U.S. patent application Ser. No. 29/525,068 for TABLET COMPUTER WITH REMOVABLE SCANNING DEVICE filed Apr. 27, 2015 (Schulte et al.);
U.S. patent application Ser. No. 14/699,436 for SYMBOL READING SYSTEM HAVING PREDICTIVE DIAGNOSTICS filed Apr. 29, 2015 (Nahill et al.);
U.S. patent application Ser. No. 14/702,110 for SYSTEM AND METHOD FOR REGULATING BARCODE DATA INJECTION INTO A RUNNING APPLICATION ON A SMART DEVICE filed May 1, 2015 (Todeschini et al.);
U.S. patent application Ser. No. 14/702,979 for TRACKING BATTERY CONDITIONS filed May 4, 2015 (Young et al.);
U.S. patent application Ser. No. 14/704,050 for INTERMEDIATE LINEAR POSITIONING filed May 5, 2015 (Charpentier et al.);
U.S. patent application Ser. No. 14/705,012 for HANDS-FREE HUMAN MACHINE INTERFACE RESPONSIVE TO A DRIVER OF A VEHICLE filed May 6, 2015 (Fitch et al.);
U.S. patent application Ser. No. 14/705,407 for METHOD AND SYSTEM TO PROTECT SOFTWARE-BASED NETWORK-CONNECTED DEVICES FROM ADVANCED PERSISTENT THREAT filed May 6, 2015 (Hussey et al.);
U.S. patent application Ser. No. 14/707,037 for SYSTEM AND METHOD FOR DISPLAY OF INFORMATION USING A VEHICLE-MOUNT COMPUTER filed May 8, 2015 (Chamberlin);
U.S. patent application Ser. No. 14/707,123 for APPLICATION INDEPENDENT DEX/UCS INTERFACE filed May 8, 2015 (Pape);
U.S. patent application Ser. No. 14/707,492 for METHOD AND APPARATUS FOR READING OPTICAL INDICIA USING A PLURALITY OF DATA SOURCES filed May 8, 2015 (Smith et al.);
U.S. patent application Ser. No. 14/710,666 for PRE-PAID USAGE SYSTEM FOR ENCODED INFORMATION READING TERMINALS filed May 13, 2015 (Smith);
U.S. patent application Ser. No. 29/526,918 for CHARGING BASE filed May 14, 2015 (Fitch et al.);
U.S. patent application Ser. No. 14/715,672 for AUGUMENTED REALITY ENABLED HAZARD DISPLAY filed May 19, 2015 (Venkatesha et al.);
U.S. patent application Ser. No. 14/715,916 for EVALUATING IMAGE VALUES filed May 19, 2015 (Ackley);
U.S. patent application Ser. No. 14/722,608 for INTERACTIVE USER INTERFACE FOR CAPTURING A DOCUMENT IN AN IMAGE SIGNAL filed May 27, 2015 (Showering et al.);
U.S. patent application Ser. No. 29/528,165 for IN-COUNTER BARCODE SCANNER filed May 27, 2015 (Oberpriller et al.);
U.S. patent application Ser. No. 14/724,134 for ELECTRONIC DEVICE WITH WIRELESS PATH SELECTION CAPABILITY filed May 28, 2015 (Wang et al.);
U.S. patent application Ser. No. 14/724,849 for METHOD OF PROGRAMMING THE DEFAULT CABLE INTERFACE SOFTWARE IN AN INDICIA READING DEVICE filed May 29, 2015 (Barten);
U.S. patent application Ser. No. 14/724,908 for IMAGING APPARATUS HAVING IMAGING ASSEMBLY filed May 29, 2015 (Barber et al.);
U.S. patent application Ser. No. 14/725,352 for APPARATUS AND METHODS FOR MONITORING ONE OR MORE PORTABLE DATA TERMINALS (Caballero et al.);
U.S. patent application Ser. No. 29/528,590 for ELECTRONIC DEVICE filed May 29, 2015 (Fitch et al.);
U.S. patent application Ser. No. 29/528,890 for MOBILE COMPUTER HOUSING filed Jun. 2, 2015 (Fitch et al.);
U.S. patent application Ser. No. 14/728,397 for DEVICE MANAGEMENT USING VIRTUAL INTERFACES CROSS-REFERENCE TO RELATED APPLICATIONS filed Jun. 2, 2015 (Caballero);
U.S. patent application Ser. No. 14/732,870 for DATA COLLECTION MODULE AND SYSTEM filed Jun. 8, 2015 (Powilleit);
U.S. patent application Ser. No. 29/529,441 for INDICIA READING DEVICE filed Jun. 8, 2015 (Zhou et al.);
U.S. patent application Ser. No. 14/735,717 for INDICIA-READING SYSTEMS HAVING AN INTERFACE WITH A USER'S NERVOUS SYSTEM filed Jun. 10, 2015 (Todeschini);
U.S. patent application Ser. No. 14/738,038 for METHOD OF AND SYSTEM FOR DETECTING OBJECT WEIGHING INTERFERENCES filed Jun. 12, 2015 (Amundsen et al.);
U.S. patent application Ser. No. 14/740,320 for TACTILE SWITCH FOR A MOBILE ELECTRONIC DEVICE filed Jun. 16, 2015 (Bandringa);
U.S. patent application Ser. No. 14/740,373 for CALIBRATING A VOLUME DIMENSIONER filed Jun. 16, 2015 (Ackley et al.);
U.S. patent application Ser. No. 14/742,818 for INDICIA READING SYSTEM EMPLOYING DIGITAL GAIN CONTROL filed Jun. 18, 2015 (Xian et al.);
U.S. patent application Ser. No. 14/743,257 for WIRELESS MESH POINT PORTABLE DATA TERMINAL filed Jun. 18, 2015 (Wang et al.);
U.S. patent application Ser. No. 29/530,600 for CYCLONE filed Jun. 18, 2015 (Vargo et al);
U.S. patent application Ser. No. 14/744,633 for IMAGING APPARATUS COMPRISING IMAGE SENSOR ARRAY HAVING SHARED GLOBAL SHUTTER CIRCUITRY filed Jun. 19, 2015 (Wang);
U.S. patent application Ser. No. 14/744,836 for CLOUD-BASED SYSTEM FOR READING OF DECODABLE INDICIA filed Jun. 19, 2015 (Todeschini et al.);
U.S. patent application Ser. No. 14/745,006 for SELECTIVE OUTPUT OF DECODED MESSAGE DATA filed Jun. 19, 2015 (Todeschini et al.);
U.S. patent application Ser. No. 14/747,197 for OPTICAL PATTERN PROJECTOR filed Jun. 23, 2015 (Thuries et al.);
U.S. patent application Ser. No. 14/747,490 for DUAL-PROJECTOR THREE-DIMENSIONAL SCANNER filed Jun. 23, 2015 (Jovanovski et al.); and
U.S. patent application Ser. No. 14/748,446 for CORDLESS INDICIA READER WITH A MULTIFUNCTION COIL FOR WIRELESS CHARGING AND EAS DEACTIVATION, filed Jun. 24, 2015 (Xie et al.).

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. A wireless headset comprising:
a headset memory operable to store a unique identifier to identify the wireless headset, wherein the unique identifier is unique to a user of the wireless headset;
a processor communicatively coupled to the headset memory, the processor configured to:
read the unique identifier from the headset memory; and
transmit a signal representing the unique identifier of the wireless headset to another wireless device such that a screen on the wireless device identifies the wireless headset with the unique identifier as available for subsequent pairing with the wireless device.

2. The wireless headset according to claim 1, wherein the headset memory comprises non-volatile memory.

3. The wireless headset according to claim 2, wherein the wireless headset comprises a headband and a receiver assembly.

4. The wireless headset according to claim 3, wherein the headset memory is in the headband.

5. The wireless headset according to claim 3, wherein the headset memory is in the receiver assembly.

6. The wireless headset according to claim 1, wherein at least a portion of the unique identifier is associated with the wireless headset.

7. The wireless headset according to claim 6, wherein the at least a portion of the unique identifier is located on the wireless headset.

8. (canceled)

9. The wireless headset according to claim 1, wherein the wireless headset is one of a plurality of wireless headsets listed on the screen, each wireless headset of the plurality of wireless headsets identified on the screen with a different unique identifier.

10. A system for identifying a wireless headset for pairing with another wireless device, the system comprising:
the wireless headset comprising:
a headset memory operable to store a unique identifier of the wireless headset, wherein the unique identifier is unique to a user of the wireless headset; and
a processor communicatively coupled to the headset memory; the processor configured to:
read the unique identifier from the headset memory; and
transmit a unique identifier signal; and
the wireless device configured to be paired to the wireless headset via a wireless communications protocol and comprising:
a memory and a program code resident in the memory;
a display configured for displaying a pairing screen for listing the wireless headset as available for pairing; and
at least one processing unit communicatively coupled to the memory and the display and configured by at least a portion of the program code to:
detect the wireless headset;
receive the unique identifier signal from the processor of the wireless headset;
display the pairing screen; and
identify the wireless headset with the unique identifier on the pairing screen as available for subsequent pairing with the wireless device.

11. The system according to claim 10, wherein the wireless headset comprises a headband.

12. The system according to claim 11, wherein the headset memory is in the headband of the wireless headset.

13. The system according to claim 11, wherein a receiver assembly is coupled to the headband of the wireless headset.

14. The system according to claim 13, wherein the headset memory is in the receiver assembly of the wireless headset.

15. (canceled)

16. The system according to claim 10, wherein the wireless headset is one of a plurality of wireless headsets listed on the screen, each wireless headset of the plurality of wireless headsets identified on the screen with a different unique identifier.

17. The system according to claim 10, wherein the wireless communications protocol comprises a Bluetooth wireless communication protocol.

18. A method for identifying a wireless headset for pairing to another wireless device comprising:
detecting a wireless headset upon initialization of a pairing process;
receiving a unique identifier signal from the wireless headset, the unique identifier signal representing a unique identifier that is unique to a user of the fireless headset;
displaying a screen; and
identifying the wireless headset on the screen with the unique identifier as available for subsequent pairing with the wireless device.

19. (canceled)

20. The method according to claim 18, wherein detecting a wireless headset comprises detecting a plurality of wireless headsets available for pairing, the wireless headset comprising one wireless headset of the plurality of wireless headsets.

21. The method according to claim 20, further comprising receiving the unique identifier signal from one or more wireless headsets of the plurality of wireless headsets.

22. The method according to claim 20, where each wireless headset of the plurality of wireless headsets broadcasts a device identifier, where the device identifier for at least one of the one or more wireless headsets is unique to that wireless headset.

23. The method according to claim 21, wherein identifying the wireless headset with the unique identifier on the screen comprises identifying each wireless headset with a different unique identifier on the screen.
